(19) United States
(12) Patent Application Publication
(10) Pub. No.: US 2007/0115900 A1
(43) Pub. Date: May 24, 2007

(54) Method and apparatus for improved voice over internet protocol (VoIP) telephone configuration

(76) Inventors: Min Liang, Westborough, MA (US); Daofa Zhang, Freehold, NJ (US)

Correspondence Address: Ryan, Mason & Lewis, LLP, 90 Forest Avenue, Locust Valley, NY, 11560, US

(21) Appl. No.: 11/286,214

(22) Filed: Nov. 22, 2005

(51) Int. Cl. H04Q 7/24

(52) U.S. Cl. 370/338

(57) ABSTRACT

A method of configuring a wireless telephone for use over a WLAN is provided. The wireless telephone is automatically configured for communication through a WLAN access point without obtaining configuration information from a user of the wireless telephone and in accordance with communication enablement information received at the wireless telephone from the WLAN access point.

### FIELD OF THE INVENTION

The present invention relates generally to the field of digital networking systems and, more particularly, to improved techniques for configuring a wireless telephone for use over a wireless local area network.

### BACKGROUND OF THE INVENTION

Voice over Internet protocol (VOIP) is a term that is used in Internet protocol (IP) telephony referring to the facilities that manage the delivery of voice information using IP. More specifically, VoIP allows for the transmission of information in digital form in discrete packets, in contrast to the conventional circuit-committed protocols of the public switched telephone network (PSTN).

VoIP technology is utilized over a wireless local area network (WLAN) in which a user can connect to a LAN through a wireless or radio connection. The IEEE 802.11 group of standards specifies the technologies for WLANs, using Ethernet protocol and carrier sense multiple access with collision avoidance (CSMA/CA) for path sharing.

In a WLAN, an access point (AP) is a station that transmits and receives data. An AP may connect users to other users within the network, and also may serve as the point of interconnection between the WLAN and a fixed wired network. Each AP can serve multiple users within a defined network area. The number of APs that are required for a WLAN is directly proportional to the number of expected network users and the physical size of the network.

A service set identifier (SSID) is a sequence of characters that provides a unique name for a WLAN. This name allows stations to connect to the network when multiple independent networks operate in the same physical area. An SSID is the 1-32 byte alphanumeric name given to a specific WLAN segment. For example, a departmental WLAN may consist of several APs and dozens of stations, all using the same SSID. Another organization in the same building may operate its own departmental WLAN, composed of APs and stations using a different SSID. The purpose of SSID is to help stations in department A find and connect to APs in department A, ignoring APs belonging to department B.

Wired equivalent privacy (WEP) is a security protocol that is designed to provide a WLAN with a level of security and privacy comparable to what is usually expected of a wired LAN. A wired LAN is generally protected by physical security mechanisms which may be ineffective for WLANs due to the fact that radio waves are not necessarily bound by the walls containing the network. WEP establishes protection for WLANs by encrypting data transmitted over the WLAN. Data encryption protects the vulnerable wireless link between clients and APs. In addition to WEP, other typical LAN security mechanisms such as password protection, end-to-end encryption, virtual private networks, and authentication may be put in place to ensure privacy.

Traditionally, the configuration of a wireless VoIP telephone for use in communicating through an AP of a WLAN is performed manually by a user via the wireless VoIP telephone keypad. The wireless VoIP telephone is physically brought into the network area of a desired AP. The wireless VoIP telephone then searches for SSIDs of available APs in that network area, and presents a list of those SSIDs that were found. The user then selects the SSID of the desired AP from the list and connects the telephone to that AP. When the AP is configured to use WEP encryption, the user must know the WEP encryption key and then enter that key into the telephone system via the keypad.

The desired AP may also be configured so that its SSID broadcast is disabled. Under this circumstance, the wireless VoIP telephone will not be able to find the SSID of the desired AP in its search. Therefore, the user must know the SSID of the desired AP a priori. It is evident that conventional wireless VoIP telephone configuration requires the user to have some basic knowledge about WLAN technology. When this knowledge is lacking, mistakes may be made during the wireless VoIP telephone configuration, requiring eventual technical support from the service provider.

Thus, a need remains for techniques that provide improved wireless VoIP telephone configuration for use in communicating through a WLAN AP that is convenient, fast and reliable, and which saves technical support resources of the service provider.

### SUMMARY OF THE INVENTION

The present invention in an illustrative embodiment provides improved wireless VoIP telephone configuration for use in communicating through an AP of a WLAN.

In accordance with one aspect of the invention, a method of configuring a wireless telephone for use over a WLAN is provided. The wireless telephone is automatically configured for communication through a WLAN access point without obtaining configuration information from a user of the wireless telephone and in accordance with communication enablement information received at the wireless telephone from the WLAN access point.

In an illustrative embodiment of the invention, the wireless telephone may be automatically configured when automatic access point configuration is enabled on the wireless telephone. Additionally, communication enablement information may be received at the wireless telephone from the WLAN AP for communication between the wireless telephone and WLAN access point. The communication enablement information may be decoded at the wireless telephone and stored in at least one configuration memory location of the wireless telephone.

In another aspect of the invention, a method of configuring a wireless telephone for use over a WLAN is provided. Communication enablement information is transmitted from an associated memory location of a WLAN AP to the wireless telephone for automatic configuration of the wireless telephone for communication through the WLAN AP without obtaining configuration information from a user of the wireless telephone.

In accordance with additional illustrative embodiments, a user-defined security protocol may be received at the WLAN AP from the wireless telephone. The user-defined security protocol may be enabled at the WLAN AP. The user-defined security protocol may be stored in a security protocol configuration location of the WLAN AP.

Advantageously, an illustrative embodiment of the present invention enables automatic configuration of a wireless VoIP telephone system, which is fast, reliable and convenient for users. The illustrative embodiment of the present invention saves resources of the service provider that would traditionally be attributed to technical support for system configuration, and thus, reduces the service operation cost. The illustrative embodiment of the present invention is also compatible with conventional manual configuration procedures.

These and other objects, features, and advantages of the present invention will become apparent from the following detailed description of the illustrative embodiments thereof, which is to be read in connection with the accompanying drawings.

### BRIEF DESCRIPTION OF THE DRAWINGS

FIG. 1 is a diagram illustrating a digital networking system, according to an embodiment of the present invention; and

FIG. 2 is a flow diagram illustrating a wireless VoIP telephone configuration methodology enabling telephone use with an AP of a WLAN, according to an embodiment of the present invention.

### DETAILED DESCRIPTION

As will be described in detail below, the present invention in the illustrative embodiment relates to improved techniques for configuring a wireless telephone for communication through a WLAN AP.

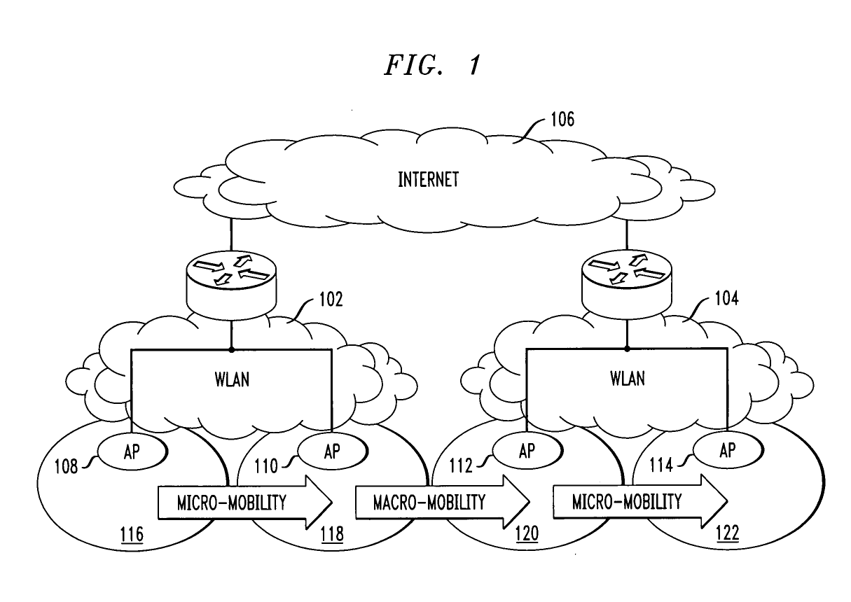

Referring initially to FIG. 1, a diagram illustrates a digital networking system, according to an embodiment of the present invention. More specifically, the diagram of FIG. 1 illustrates the delivery of voice information using an IP. A first WLAN 102 and a second WLAN 104 are in communication with Internet 106. First WLAN 102 has a first AP 108 and a second AP 110. Second WLAN 104 also has a first AP 112 and a second AP 114.

Each AP 108, 110, 112 and 114, has its own corresponding network area for providing access to a WLAN for those devices physically within that network area and configured for communication with that AP. This access to the WLAN thereby provides access to Internet 106. For example, AP 108 provides access for wireless VoIP telephones physically within network area 116, AP 110 provides access for wireless VoIP telephones physically within network area 118, AP 112 provides access for wireless VoIP telephones physically within network area 120, and AP 114 provides access for wireless VoIP telephones physically within network area 122. In order for communication to be enabled, a wireless VoIP telephone that enters one of the above mentioned network areas is configured for communication with the respective AP.

Physical movement between network areas 116 and 118, and between network areas 120 and 122 is considered micro-mobility because the respective APs provide access to the same WLAN. The wireless VoIP telephone may not have to be reconfigured for use with the new AP when the new AP provides access to the same WLAN segment as the old AP. However, if the new AP provides access to a different WLAN segment, reconfiguration of the wireless VoIP telephone may be necessary for use in communicating with the new AP. Movement between ranges 118 and 120 is considered macro-mobility because the respective APs provide access to different WLANs. With regard to macro-mobility, a wireless VoIP telephone a must be reconfigured for use in communicating with the new AP.

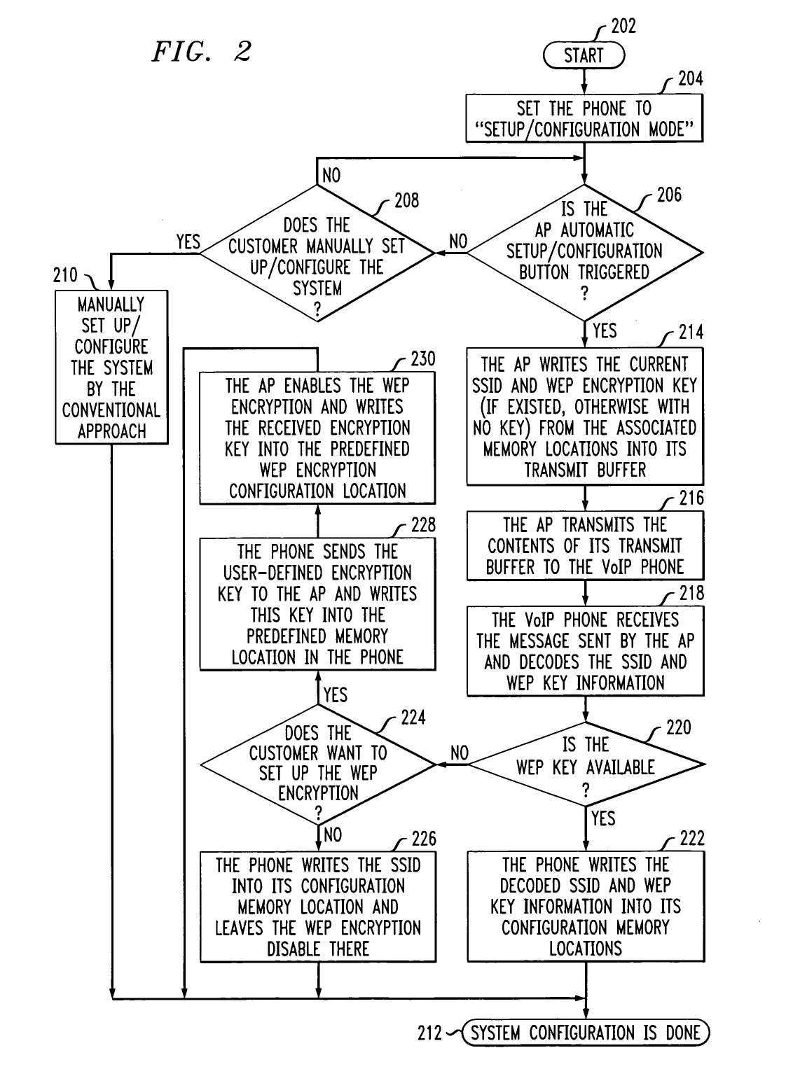

Referring now to FIG. 2, a flow diagram illustrates a wireless VoIP telephone configuration methodology for enabling telephone use with a WLAN AP, according to an embodiment of the present invention. The methodology begins in block 202. In block 204, the wireless VoIP telephone is set to a configuration or setup mode. A user may select an automatic configuration of the wireless VoIP telephone for use in communicating with a WLAN AP, or manual configuration of the wireless VoIP telephone for use in communicating with the WLAN AP. In block 206, it is determined if the automatic AP configuration has been activated. In accordance with a preferred embodiment of the present invention, the automatic AP configuration may be activated by depressing a predefined button on the wireless VoIP telephone, allowing for one-touch-button configuration of the wireless VoIP telephone.

If the automatic AP configuration has not been activated, it is determined if the user will manually configure the system for use with a WLAN AP in block 208. If the user will not manually configure the system, the methodology returns to block 206 to determine if the automatic AP configuration is activated. If the user will manually configure the system, the system is manually configured in block 210 through a conventional approach described above. The system configuration for use with a WLAN AP is complete in block 212, terminating the methodology.

If it is determined that the automatic AP configuration of the wireless VoIP telephone has been activated, the AP writes communication enablement information for the AP from associated memory locations into a transmit buffer of the AP in block 214. In a preferred embodiment, the communication enablement information includes the WLAN segment identifier for the AP such as, for example, an SSID. The communication enablement information may also include a WLAN security protocol if it exists in the AP, more specifically, if this AP has data encryption security. In a preferred embodiment, the WLAN security protocol is a WEP encryption key. In block 216, the AP transmits the contents of the transmit buffer, preferably in form of a short frame in its intrinsic modulation, to the wireless VoIP telephone that has physically entered the network area of the AP and that has its automatic configuration activated. In block 218, the wireless VoIP telephone detects the short frame, receives the message sent by the AP and decodes the SSID information, as well as WEP key information when available.

In block 220, it is determined at the wireless VoIP telephone if the WEP key information was available. If the WEP key information was available, the wireless VoIP telephone writes the decoded SSID and WEP key information into its configuration memory locations in block 222, automatically completing the system configuration in block 212 and terminating the methodology.

If the WEP key information was not available, and only the SSID information was sent by the AP, it is determined if the user desires to set up a WEP encryption in block 224. If the user does not desire to set up a WEP encryption, the wireless VoIP telephone writes the SSID into its configuration memory location and leaves the WEP encryption of the AP disabled in block 226, automatically completing the system configuration in block 212 and terminating the methodology.

If the user desires to set up a WEP encryption, the user specifies an encryption and the wireless VoIP telephone sends a user-defined encryption key to the AP and writes this key into a predefined memory location in the wireless VoIP telephone in block 228. In block 230, the AP receives the user-defined encryption key from the wireless VoIP telephone, enables the WEP encryption and writes the user-defined encryption key into a predefined WEP encryption configuration location of the AP. The system configuration is then complete in block 212, terminating the methodology.

Upon termination of the methodology in block 212, the wireless VoIP telephone is configured for communication with a desired AP having a network area that the VoIP telephone is within. The VoIP telephone may then transmit communication through the AP, the WLAN and Internet to desired destinations as defined by transmitted voice packets.

Accordingly, as described herein, the present invention in the illustrative embodiment provides improved techniques for configuring a wireless VoIP telephone for use with an AP for communicating through a WLAN and the Internet.

Additional embodiments of the present invention may incorporate various numbers and combinations of WLANs, APs and wireless VoIP telephones. Further, additional embodiments may include additional user devices that communicate over the WLAN such as, for example, computers and televisions. Additionally, a WLAN of the present invention may provide connections to wired LANs and other networks in addition to secondary WLANs and the Internet. The embodiments of the present invention may be applied to any methods of system configuration for wireless VoIP telephones, any methods of IEEE 802.11 wireless system configuration, or any other data wireless communication system configuration.

The elements of the wireless VoIP telephone and the AP of the present invention may be considered one or more integrated circuit devices. Regarding integrated circuits in general, a plurality of identical die are typically formed in a repeated pattern on a surface of a semiconductor wafer. Each die may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

Therefore, although illustrative embodiments of the present invention have been described herein with reference to the accompanying drawings, it is to be understood that the invention is not limited to those precise embodiments, and that various other changes and modifications may be made by one skilled in the art without departing from the scope of the invention as defined by the claims.

What is claimed is:

1. A method of configuring a wireless telephone for use over a wireless local area network (WLAN) comprising the step of:
automatically configuring the wireless telephone for communication through a WLAN access point without obtaining configuration information from a user of the wireless telephone and in accordance with communication enablement information received at the wireless telephone from the WLAN access point.

2. The method of claim 1, wherein, in the step of automatically configuring the wireless telephone, the wireless telephone is automatically configured when automatic access point configuration is enabled on the wireless telephone.

3. The method of claim 2, wherein automatic access point configuration is enabled through activation of a button on the wireless telephone.

4. The method of claim 1, wherein the step of automatically configuring the wireless telephone comprises the steps of:
receiving at the wireless telephone, communication enablement information from the WLAN access point for communication between the wireless telephone and the WLAN access point;
decoding the communication enablement information at the wireless telephone; and
storing the communication enablement information in at least one configuration memory location of the wireless telephone.

5. The method of claim 4, wherein the communication enablement information comprises a WLAN segment identifier for the access point.

6. The method of claim 5, wherein the WLAN segment identifier for the access point comprises a service set identification for the WLAN access point.

7. The method of claim 5, further comprising the steps of:
transmitting a user-defined security protocol from the wireless telephone to the WLAN access point; and
storing the user-defined security protocol in the at least one configuration memory location of the wireless telephone.

8. The method of claim 5, wherein the communication enablement information further comprises a WLAN security protocol.

9. The method of claim 8, wherein the WLAN security protocol comprises a wired equivalent privacy encryption key of the WLAN access point.

10. The method of claim 1, wherein the wireless telephone comprises a voice over Internet protocol telephone.

11. A method of configuring a wireless telephone for use over a WLAN comprising the step of:
transmitting communication enablement information from an associated memory location of a WLAN access point to the wireless telephone for automatic configuration of the wireless telephone for communication through the WLAN access point without obtaining configuration information from a user of the wireless telephone.

12. The method of claim 11, wherein the communication enablement information comprises a WLAN segment identifier for the access point.

13. The method of claim 12, further comprising the steps of:
receiving a user-defined security protocol at the WLAN access point from the wireless telephone;
enabling the user-defined security protocol at the WLAN access point; and
storing the user-defined security protocol in a security protocol configuration location of the WLAN access point.

14. The method of claim 11, wherein the communication enablement information further comprises a WLAN security protocol.

15. The method of claim 14, wherein the WLAN security protocol comprises a wired equivalent privacy encryption key of the WLAN access point.

16. An apparatus for configuring a wireless telephone for use over a WLAN comprising:
circuitry for automatically configuring the wireless telephone for communication through a WLAN access point without obtaining configuration information from a user of the wireless telephone and in accordance with communication enablement information received at the wireless telephone from the WLAN access point.

17. The apparatus of claim 16, wherein the circuitry for automatically configuring the wireless telephone further comprises:
circuitry for receiving at the wireless telephone, communication enablement information from the WLAN access point for communication between the wireless telephone and the WLAN access point;
circuitry for decoding the communication enablement information at the wireless telephone; and
circuitry for storing the communication enablement information in at least one configuration memory location of the wireless telephone.

18. An apparatus for configuring a wireless telephone for use over a WLAN comprising:
circuitry for transmitting communication enablement information from an associated memory location of a WLAN access point to the wireless telephone for automatic configuration of the wireless telephone for communication through the WLAN access point without obtaining configuration information from a user of the wireless telephone.

19. An integrated circuit device for use in a wireless telephone for configuring the wireless telephone for use over a WLAN, wherein the integrated circuit device is configured to automatically configure the wireless telephone for communication through a WLAN access point without obtaining configuration information from a user of the wireless telephone and in accordance with communication enablement information received at the wireless telephone from the WLAN access point.

20. The integrated circuit device of claim 19, further configured to: (i) receive at the wireless telephone, communication enablement information from the WLAN access point for communication between the wireless telephone and the WLAN access point; (ii) decode the communication enablement information at the wireless telephone; and (iii) store the communication enablement information in at least one configuration memory location of the wireless telephone.

21. An integrated circuit device for use in a WLAN access point for configuring a wireless telephone for use over a WLAN, wherein the integrated circuit device is configured to transmit communication enablement information from an associated memory location of the WLAN access point to the wireless telephone for automatic configuration of the wireless telephone for communication through the WLAN access point without obtaining configuration information from a user of the wireless telephone.

22. A digital networking system comprising:
a wireless telephone comprising an integrated circuit device configured to automatically configure the wireless telephone for use over a WLAN without obtaining configuration information from a user of the wireless telephone and in accordance with communication enablement information received at the wireless telephone; and
a WLAN access point comprising an integrated circuit device configured to transmit the communication enablement information from an associated memory location of the WLAN access point to the wireless telephone for automatic configuration of the wireless telephone for communication through the WLAN access point.
